(19) United States
(12) Patent Application Publication
(10) Pub. No.: US 2023/0049026 A1
(43) Pub. Date: Feb. 16, 2023

(54) ACTUATOR COMPRISING AN INNERVATED LIQUID CRYSTAL ELASTOMER

(71) Applicants: President and Fellows of Harvard College, Cambridge, MA (US); Trustees of Boston University, Boston, MA (US)

(72) Inventors: Arda Kotikian, Concord, MA (US); Jennifer A. Lewis, Cambridge, MA (US); Javier M. Morales Ferrer, Allston, MA (US); John William Boley, Cambridge, MA (US)

(21) Appl. No.: 17/743,804

(22) Filed: May 13, 2022

Related U.S. Application Data
(60) Provisional application No. 63/188,896, filed on May 14, 2021.
(60) Provisional application No. 63/241,618, filed on Sep. 8, 2021.

(51) Int. Cl. B29C 64/118; B33Y 10/00; B33Y 80/00

(52) U.S. Cl. CPC B29C 64/118; B33Y 10/00; B33Y 80/00; B29K 2105/0079

(57) ABSTRACT

A method of forming an innervated liquid crystal elastomer (iLCE) actuator comprises extruding a filament through a nozzle moving relative to a substrate, where the filament has a core-shell structure including a shell comprising a liquid crystal elastomer surrounding a core configured to induce a nematic-to-isotropic transition of the liquid crystal elastomer. The filament is subjected to UV curing as the filament is extruded, and the filament is deposited on the substrate as the nozzle moves. A director of the liquid crystal elastomer is aligned with a print path of the nozzle, and a 3D printed architecture configured for actuation is formed.

### RELATED APPLICATIONS

The present patent document claims the benefit of priority under 35 U.S.C. 119(e) to U.S. Provisional Patent Application No. 63/241,618, filed on Sep. 8, 2021, and to U.S. Provisional Patent Application No. 63/188,896, filed on May 14, 2021. Both of the above-mentioned patent applications are hereby incorporated by reference in their entirety.

### FEDERALLY SPONSORED RESEARCH AND DEVELOPMENT

This invention was made with government support under 2011754 and 1922321 awarded by the National Science Foundation, and under FA9550-20-1-0365 awarded by the U.S. Air Force Office of Scientific Research, and under W911 NF-17-1-0351 awarded by the U.S. Army Research Office. The government has certain rights in the invention.

### TECHNICAL FIELD

The present disclosure is related generally to liquid crystal elastomers and more particularly to liquid crystal elastomers configured for actuation.

### BACKGROUND

Liquid crystal elastomers are soft active materials that may have applications in soft robotics, actuators, and shape shifting architectures. These elastomers include a crosslinked polymer network that contains rigid mesogens, which may actuate when heated above their nematic-to-isotropic transition temperature (T_{NI}) or exposed to another stimulus. When the mesogen alignment of a liquid crystal elastomer is programmed along a specified direction, known as the director, the active material may exhibit large, reversible, and anisotropic contraction with high energy density parallel to the director. Initial methods to program director alignment have been limited to thin films and one-dimensional (1D) motifs, including bulk liquid crystal elastomers with mechanically induced alignment.

### BRIEF DESCRIPTION OF THE DRAWINGS

FIG. 1 shows a schematic of an innervated liquid crystal elastomer actuator, or iLCE actuator, comprising a 3D printed core-shell filament in an as-printed configuration (top) and in a contracted configuration (bottom) after actuation.

FIG. 2 shows fabrication of an iLCE via extrusion-based 3D printing.

FIGS. 3A and 3B show optical and corresponding thermal images of representative iLCE actuators actuated with discrete power inputs ranging from 1-40 mW mm⁻², which increase from left to right, as labeled (scale bar=5 mm).

FIG. 3C shows a thermal model of the temperature across the iLCE actuator (cross-section) at these discrete power inputs, where inner and outer black outlines indicate initial dimensions of the core (core material) and the shell (liquid crystal elastomer), respectively.

FIG. 3D shows measured surface temperature, surface temperature extracted from the thermal model, and average R/R₀ of iLCEs at various discrete power inputs.

FIG. 4 shows L/L₀ and R/R₀ with respect to time of a representative iLCE at various discrete power inputs.

FIG. 5 shows average L/L₀, average R/R₀, and theoretical R/R₀ modeled with Ohm's law with resistivity temperature correction for discrete power inputs, where the error bars indicate standard deviations.

FIG. 6 shows a schematic of reversible iLCE actuation (left) and a plot of measured L/L₀ and R/R₀ when cycled at low (10 mW mm⁻²) and high (40 mW mm⁻²) power inputs (right).

FIG. 7 shows a schematic of iLCEs lifting weight (left) and a plot of measured L/L₀ and specific work (work by LCE mass) when lifting different weights at discrete power inputs (right), where error bars indicate standard deviations.

FIG. 8A shows optical images of a representative iLCE fiber with self-adjusting actuation under several loading conditions (scale bar=10 mm).

FIG. 8B shows a self-adjusting current profile (top) and change in resistance and length (bottom) as a function of time for iLCE fibers that are perturbed with bias loads, while reaching target values of resistance (black, dashed) and corresponding length (red, dashed), where the lines denote average values, and shaded regions or error bars indicate standard deviations.

FIG. 9A shows side-view images of a printed iLCE when cycled between off (0 mW mm⁻², left) and on (5 mW mm⁻², right) power input, and a top-view image of the printed iLCE spiral architecture (off state) is shown in the inset.

FIG. 9B shows average height and resistance profile of printed iLCE spiral architectures cycled at a power input of 5 mW mm⁻².

FIG. 9C shows side-view images of a printed iLCE when cycled between off (0 mW mm⁻², left) and on (15 mW mm⁻², right) power input

FIG. 9D shows average height and resistance profile as a function of time for printed iLCE spiral architectures cycled at 15 mW mm⁻² power, where the plots do not include the first cycle.

FIG. 9E shows an image sequence of a printed iLCE spiral architecture.

FIG. 9F shows a resistance profile of actuation for the iLCE of FIG. 9E as a function of time with closed loop control (bottom), where the target resistance is shown as a dashed line.

### DETAILED DESCRIPTION

Extrusion-based 3D printing is used to induce director alignment along the print path enabling 3D liquid crystal elastomers to be fabricated with programmed shape-morphing behavior, actuation response, and seamless integration with other materials. The programmable assembly of what may be termed innervated liquid crystal elastomer (“iLCE”) actuators, which may include a core material designed to activate the liquid crystal elastomer, is described. The iLCE actuators (referred to alternately as “iLCEs” or “actuators”) may exhibit prescribed contractile actuation, self-sensing, and closed loop control via core-shell 3D printing.

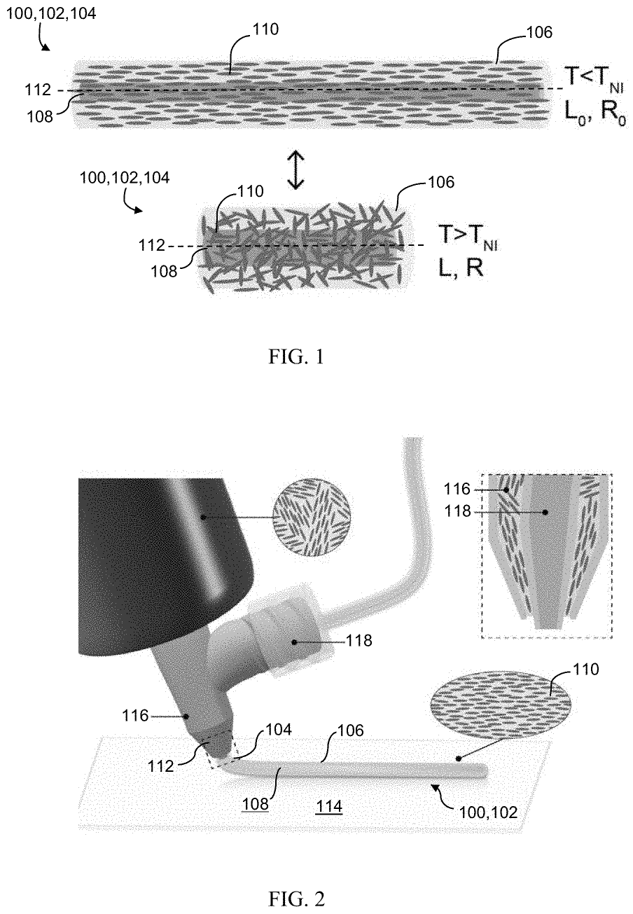

Referring to FIG. 1, the actuator or iLCE 100 may comprise a 3D printed architecture 102 including a filament 104 having a core-shell structure. The shell 106 comprises a liquid crystal elastomer and surrounds a core 108 configured to induce a nematic-to-isotropic transition of the liquid crystal elastomer. The core 108 may be partially or completely filled with a core material or may be hollow. In other words, the core 108 may contain a core material or may be a hollow core that does not include a core material, as further discussed below. As a consequence of 3D printing, a director 110 of the liquid crystal elastomer is aligned with a longitudinal axis 112 of the filament 104, as shown in the top schematic. When the nematic-to-isotropic transition of the liquid crystal elastomer is activated or induced (e.g., by exposure to light, heat, voltage, and/or a chemical gradient via the core 108), the director 110 alignment is lost, allowing the 3D printed architecture 100 to be actuated, as illustrated in the bottom schematic. Due to the change in molecular orientation, the filament 104 contracts along the longitudinal axis 112 and may undergo a contractile strain AL/L₀ in excess of 50%, where AL represents the change in length after actuation (L₀−L) and L₀ represents the initial length.

The core 108 may be configured via the core material or the hollow core to transmit, deliver or generate light, heat, a voltage, a chemical gradient and/or another activator in order to activate the nematic-to-isotropic transition. For example, the core material may comprise an electrically conductive material and/or a light transmissive material, such as a liquid metal or a polymer (e.g., a conductive polymer, a light transmissive polymer). The conductive polymer may comprise conductive particles in a flowable or extrudable polymeric matrix or carrier; examples may include carbon grease, metal pastes, and/or other soft composite electronics formulations. A light transmissive polymer may serve as a waveguide for light propagation through the core 108 to activate a photoresponsive liquid crystal elastomer; a suitable polymer may comprise, for example, a flowable silicone polymer, such as Sylgard 184. It is noted that the core material may in some examples be incorporated into the filament 104 after 3D printing to replace a sacrificial or “fugitive” material employed during the printing process. For example, a suitable fugitive material may comprise a hydrogel such as poloxamer, which may form a gel at a higher temperature for printing and may be liquid at low temperatures for extraction from the core 108. It is also contemplated that, after extraction of the fugitive material, the core 108 may remain hollow as indicated above; such a configuration may be suitable when the activator for the nematic-to-isotropic transition of the liquid crystal elastomer can be transmitted through a gaseous medium such as air. In the examples discussed below, where the core material comprises a liquid metal, heat may be generated in the core 108 by passing a current through the core material (i.e., joule heating or resistive heating), thereby activating a thermoresponsive liquid crystal elastomer. In such a case, the nematic-to-isotropic transition occurs once the liquid crystal elastomer reaches the nematic-to-isotropic transition temperature. Suitable liquid metals may include Ga, In, Sn, and/or Hg.

Notably, due to the core-shell 3D printing process described in detail below, the filaments 104 may include a uniquely large loading level of the liquid metal, polymer or other core material. For example, the core 108 may have a transverse cross-sectional area that is at least about 40% as large, at least about 50% as large, or at least about 60% as large as the total transverse cross-sectional area of the filament. In examples where the core material comprises a liquid metal, the relatively large cross-sectional area of the core 108 may facilitate achieving a high average current and elevated heat generation during joule heating, as discussed below.

The iLCE 100 may have a single nematic-to-isotropic transition or may be configured to exhibit more than one nematic-to-isotropic transition. For example, the shell may 106 may be formed to include more than one liquid crystal elastomer, arranged for example in concentric layers or in a longitudinal stack. In such a case, the iLCE may be configured to contract in a gradual or step-wise fashion as the liquid crystal elastomers are activated at different times. More specifically, the shell 106 may include a first liquid crystal elastomer having a first nematic-to-isotropic transition and a second liquid crystal elastomer having a second nematic-to-isotropic transition, where the first and second nematic-to-isotropic transitions may be induced at different temperatures, wavelengths, voltages and/or chemical gradients. In one example, the shell 106 may include an inner radial layer and an outer radial layer comprising, respectively, the first and second liquid crystal elastomers. In another example, the shell 106 may include a longitudinal first portion and a longitudinal second portion comprising, respectively, the first and second liquid crystal elastomers. It is understood that descriptions of or references to the “liquid crystal elastomer” throughout this disclosure may refer to any or all of the first, second, or additional liquid crystal elastomers that may be part of the shell 108.

Examples of liquid crystal elastomers may include azobenzene-containing liquid crystal elastomers AzBz-LCE, polysiloxane-based liquid crystal elastomers PSX-LCE, chiral molecule containing-cholesteric liquid crystal elastomers, Ch-LCE, and/or fluoro-substituted liquid crystal elastomers F-LCE, such as 1,2,4,5-tetrakis((4-(alkoxy)phenyl)ethynyl)benzenes on each side-arm. The liquid crystal elastomer may be described as a main-chain and/or a side-chain liquid crystal elastomer. Examples of main and side chain mesogens may include acrylate derivative side chain, vinyl derivative side chain, acrylate main chain, and vinyl main chain mesogens. Acrylate derivative side-chain mesogens may be formed from the pentyl-oxycyanobiphenyl mesogenic unit with a terminal acrylate group, which may function to make a side-chain liquid crystal elastomer. The associated main chain liquid crystal elastomer can be formed by connected end-to-end individual mesogens by a thiol chain linker, an amine linker, a di-methylhydrosiloxane linker and a multifunctional crosslinker molecule (e.g, (1,3,5-triallyl-1,3,5-triazine-2,4,6(1H,3H,5H)-trione), where the function of these molecules may be to polymerize mesogens or connect the polymerized main chain mesogens.

A method of making the iLCE 100 is described in reference to FIG. 2. The method includes extruding a filament 104 through a nozzle 112 moving relative to a substrate 114, and subjecting the filament 104 to UV curing as the filament is extruded. The UV curing may be carried out using ultraviolet light having an intensity in a range from about 6 mW cm⁻² to about 10 mW cm⁻². The filament 104 has a core-shell structure including a shell 106 comprising a liquid crystal elastomer surrounding a core 108, which may comprise a core material configured to induce a nematic-to-isotropic transition of the liquid crystal elastomer or a fugitive material that is removed after 3D printing. Advantageously, the liquid crystal elastomer and the core or fugitive material are flowable and/or viscoelastic (e.g., may exhibit shear thinning behavior), or may be rendered flowable and/or viscoelastic, to permit flow through the nozzle 112. The filament 104 is deposited on the substrate 114 as the nozzle 112 moves, and a director 110 of the liquid crystal elastomer is aligned with a print path of the nozzle 112. In examples where the core 108 comprises the fugitive material, the method may further comprise, after depositing the filament 104 on the substrate 114, removing the fugitive material from the core 108 so as to form, in some cases, a hollow core for transmission of an activator of the nematic-to-isotropic transition. In other examples, after removal of the fugitive material from the core 108, a core material configured to induce the nematic-to-isotropic transition may be introduced into the core 108. As described above, the nematic-to-isotropic transition of the liquid crystal elastomer may be activated by light, heat, voltage, a chemical gradient, and/or another activator that may be transmitted, delivered or generated by the core material or transmitted through the hollow core. Thus, a 3D printed architecture 102 configured for actuation is formed. The 3D printed architecture 102, which includes the filament 104 having the core-shell structure, may have any of the features and properties described above or elsewhere in this disclosure.

Referring to the inset of FIG. 2, the nozzle 112 may include a core channel 116 and a shell channel 118 surrounding the core channel 116. Prior to the extrusion, the core or fugitive material passes through the core channel 116 and the liquid crystal elastomer passes through the shell channel 118. As illustrated in the inset, the shell channel 118 may be retracted relative to the core channel 116 at an exit of the nozzle 112, such that the liquid crystal elastomer exits the shell channel 118 before the core or fugitive material exits the core channel 116. During the extrusion, the nozzle 112 may be inclined at an angle between 1° and 60° and/or between 5° and 45° with respect to an axis normal to the substrate 114, as illustrated in FIG. 2. Accordingly, the filament 104 may have an elliptical cross-section. This may be particularly beneficial when the core material comprises a liquid metal. Alternatively, the nozzle 112 may be substantially normal to the substrate 114, and the filament 104 may have a substantially circular cross-section.

The extrusion may be controlled such that one or both of the core or fugitive material and the liquid crystal elastomer pass through the respective channel 116,118 at a predetermined flow rate. In one example, the predetermined flow rate may lie in a range from about 0.01 ml/min and about 0.1 ml/min. Also or alternatively, the extrusion may be controlled such that one or both of the core or fugitive material and the liquid crystal elastomer pass through the respective channel 116,118 at a predetermined pressure. In one example, the predetermined pressure may lie in a range from about 1 MPa to about 10 MPa. The nozzle 112 may move relative to the substrate 114 at a print speed in a range from about 0.5 mm/s to about 5 mm/s. It is understood that “a nozzle moving relative to a substrate” encompasses all of the following situations: the nozzle is moved and the substrate is stationary; the substrate is moved and the nozzle is stationary; and both the nozzle and the substrate are moved. During the extrusion, the nozzle 112 is preferably maintained at a predetermined temperature. In some examples, a flexible heater may be wrapped about the nozzle 112.

The method may include over-extruding the liquid crystal elastomer at a beginning and an end of the extrusion to seal the core material. The director alignment may be locally disrupted due to the sealing. To achieve the over-extruding, the print speed may be reduced by at least about a factor of 1.5, or at least about a factor of 2. Also or alternatively, after depositing the filament 104 on the substrate, the filament 104 may be subjected to an additional UV curing step to fully crosslink the liquid crystal elastomer. The additional UV curing step may be carried out by exposing the filament 104 to ultraviolet light for at least about 20 min, or at least about 30 min. In some examples, the additional UV curing step is carried out using UV light having an intensity in a range from about 3 mW cm⁻² to about 7 mW cm⁻².

As indicated above, a 3D printed architecture 102 configured for actuation may be formed by the core-shell printing method. An actuation method for the 3D printed architecture 102 is also described in this disclosure. The method includes providing a 3D printed architecture 102 comprising a filament 104 having a core-shell structure, where the core-shell structure includes a shell 106 comprising a liquid crystal elastomer surrounding a core 108 configured to induce a nematic-to-isotropic transition of the liquid crystal elastomer, and where a director 110 of the liquid crystal elastomer is aligned with a longitudinal axis 112 of the filament 104. The core 108 may be a hollow core configured for transmission of an activator of the nematic-to-isotropic transition of the liquid crystal elastomer, or the core 108 may contain (e.g., be partly or completely filled with) a core material configured to induce (activate) the nematic-to-isotropic transition of the liquid crystal elastomer. The method further comprises inducing the nematic-to-isotropic transition of the liquid crystal elastomer to actuate the 3D printed architecture 102. As described above in reference to FIG. 1, when the phase transition occurs, the director 110 alignment is lost, and the filament 104 contracts along the longitudinal axis 112 or print path due to the change in molecular orientation. The nematic-to-isotropic transition of the liquid crystal elastomer may be induced by exposing the liquid crystal elastomer to light, heat, voltage, a chemical gradient, and/or another activator that may be delivered or generated by the core material or transmitted through the hollow core. The 3D printed architecture 102 may include more than one nematic-to-isotropic transition, as described above, and more than one liquid crystal elastomer. In such examples, the iLCE 100 or 3D printed architecture 102 may be configured to contract in a gradual or step-wise fashion as the liquid crystal elastomers are activated at different times. It is understood that the 3D printed architecture 102 may have any of the features and properties described above or elsewhere in this disclosure.

### EXAMPLES

Examples of the programmable assembly of innervated LCE actuators (iLCEs) with prescribed contractile actuation, self-sensing, and closed loop control via core-shell printing are described below. As set forth above, extrusion-based direct ink writing enables the printing of coaxial filaments 104 including a core 108 comprising a core material (a liquid metal in these examples) surrounded by a shell 106 comprising a liquid crystal elastomer, whose director 110 is aligned along the print path, as illustrated in FIG. 2. The thermal response of such iLCE fiber-type actuators 100 during Joule heating are modeled, fabricated and measured, including quantification of the concomitant changes in fiber length and resistance that arise during simultaneous heating and self-sensing. Due to their reversible, high-energy actuation and resistive-based sensory feedback, iLCEs can be regulated with closed loop control even when perturbed with large bias loads, as demonstrated. Finally, iLCE architectures capable of programmed, self-sensing 3D shape change with closed loop control are described.

To fabricate the iLCEs, a liquid metal and a photopolymerizable main-chain liquid crystal elastomer are co-extruded through a core-shell nozzle mounted on a custom-built, direct ink writing platform. To promote sufficient shear and extension during extrusion to achieve the desired alignment of the director to a prescribed print path, the shell channel 116 may be retracted relative to the core channel 118 and the nozzle may be tilted (20° in this example) from vertical, as illustrated in FIG. 2. This retraction and/or tilting are particularly beneficial for printing a core material comprising a liquid metal, but may not be required in all cases. The iLCEs of this example are printed within the nematic phase at 25° C. and subjected to UV curing immediately upon exiting the core-shell nozzle to preserve the prescribed director alignment and the uniformity of liquid metal deposition. The liquid crystal elastomer ink may be over-extruded at the beginning and end of the iLCE printing process to locally disrupt director alignment in those regions as described above, thereby facilitating connection to electrical leads with minimal actuation at each end as well as sealing the liquid metal to prevent auto-evacuation.

When heated above T_{NI}, the iLCEs 100 contract in their designated print direction 112 with correlated self-sensing, as illustrated in FIG. 1. Since their actuation response is gradual, a T_{NI} of 127° C. may be defined as the temperature at which maximum LCE actuation is first observed. When iLCE fibers are heated above T_{NI} via Joule heating, they exhibit a pronounced actuation response.

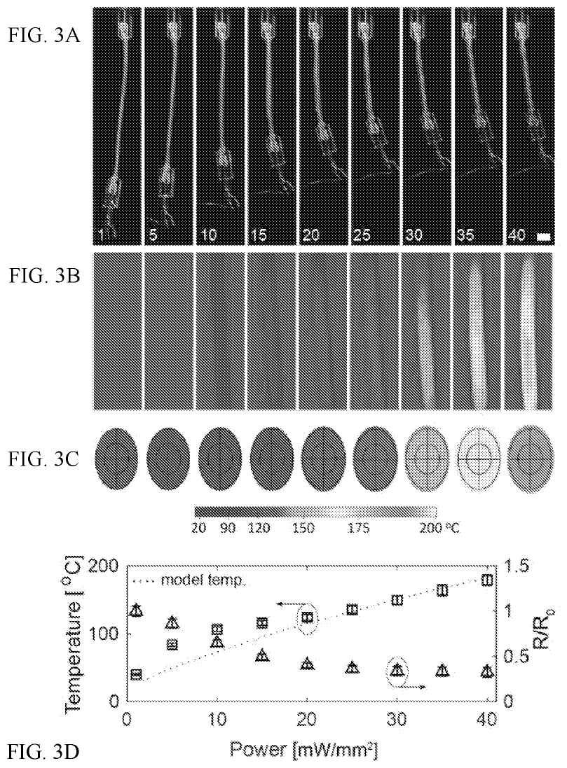

It is possible to control the actuation behavior of iLCEs by modulating the Joule heating power, as illustrated in FIG. 3A. Notably, these iLCEs exhibit uniaxial contractile strains comparable to pure 3D printed LCEs. The power input is normalized by the initial interfacial area associated with the liquid metal core and the liquid crystal elastomer shell regions between connection leads to enable direct comparison between printed iLCEs, where power input reflects the current input and initial resistance. The surface temperature of the iLCE fibers is then characterized at discrete power inputs, as shown in FIG. 3B. As expected, the center of the iLCE fibers exhibits the highest temperature, which increases with power input up to a maximum value of 178.7° C.±4.4% at 40 mW mm⁻². Importantly, core-shell printing allows iLCE fibers to be produced with relatively large liquid metal cross-sections relative to other patterning methods, enabling high average current and low maximum voltage inputs (i.e., 9.28 A±5.5% at 0.5315 V±6.5%) and consequently elevated heat generation at attainable maximum current densities of 29.6 A mm⁻²±3.3% (40 mW mm⁻²) without electrical failure. To predict thermal behavior, the thermal response is modeled across the cross-sectional area and length of the iLCE fibers. Given their architecture, a minimal temperature gradient is expected through the cross-section of the liquid crystal elastomer, as shown in FIG. 3C, and a moderate heat gradient along the length of the fiber. The modeled surface temperature is in good agreement with experimental maximum surface temperature, as indicated in FIG. 3D. Resistance decreases with heat due to the change in geometry of the actuator, with a plateau in normalized resistance (R/R₀) above 25 mW mm⁻², also corresponding to the power at which the entire iLCE fiber is expected to be above its T_{NI} (127° C.).

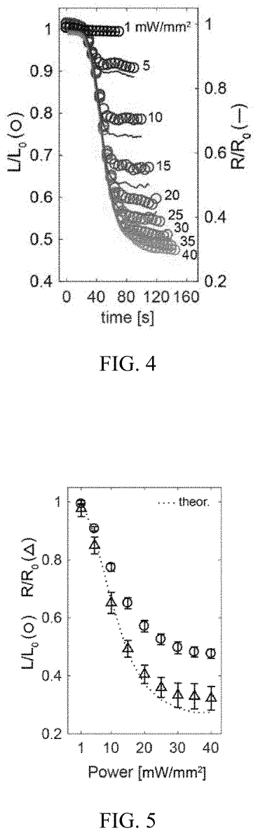

The programmable shape change and predictable self-sensing performance of these iLCE fibers are also investigated. As expected, their actuation at different power inputs shows that R/R₀ is closely correlated with normalized length (L/L₀) during Joule heating, as shown in FIG. 4, and also with cooling. Hence, changes in L/L₀ and R/R₀ may be dependently programmable with power input, as shown by the data of FIG. 5, i.e., greater contractile strain may result in greater decrease in resistance. Since resistance depends on both geometry and temperature, it can be predicted taking the temperature generated and strain of iLCEs at discrete power inputs (Eq. 1), accounting for both the change in geometry and temperature, where a is the temperature coefficient of resistivity

$$\frac{R}{{R}_{0}} = [ 1 + α ( T - {T}_{0} ) ] {( \frac{L}{{L}_{0}} )}^{2} \qquad ( 1 )$$

To achieve more reliable changes in L/L₀ and R/R₀, the current may be ramped up and down. However, iLCEs can be rapidly actuated by applying a step input power of 40 mW mm⁻², in which over 90% of their maximum contractile strain is attained within 10 s.

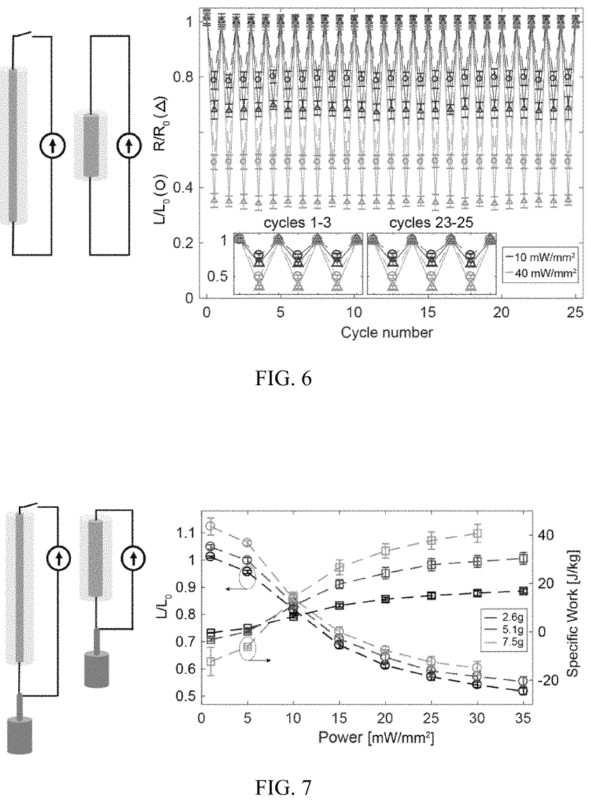

To characterize actuator performance, iLCE actuation strain repeatability and work output are explored. When cycled between on and off states 25 times, iLCEs exhibit average L/L₀=0.79±0.5% and R/R₀=0.68±0.7% or L/L₀=0.49±0.1% and R/R₀=0.35±0.9% for low (i.e., 10 mW mm⁻²) and high power (i.e., 40 mW mm⁻²) on states, respectively, as shown in FIG. 6. Notably, iLCEs demonstrate repeatable programming of L/L₀ and resulting R/R₀ at both partial and full actuation, which are closely correlated throughout the duration of the power profile used. Next, iLCEs underwent Joule heating at several power inputs and bias loads in weight-lifting experiments. Akin to unstressed iLCE experiments, increasing power input results in larger strains, but decreases with larger bias loads, and work exertion increases with both power input and bias load, as shown in FIG. 7. It is found that 30 mW mm⁻² power and 7.5 g bias load are the maximum power and loading conditions that these iLCEs can reliably lift. Upon heating, LCE actuators increase in length prior to contracting with sufficient bias loads, as observed for other LCEs that are not monodomain. If total contraction results in length greater than the initial unbiased length (L₀), it is defined as an extension (i.e., L/L₀>1) and negative work output. Overall, iLCEs lift bias loads over 200 times their own LCE weight, with maximum specific work (40.7 J kg⁻¹±9.1%) comparable to our prior observations for pure LCEs. To further increase their work output, the cross-sectional area of the active material can be increased either by printing bundled iLCE fibers or patterning pure LCEs alongside these fiber(s) via multimaterial 3D printing.

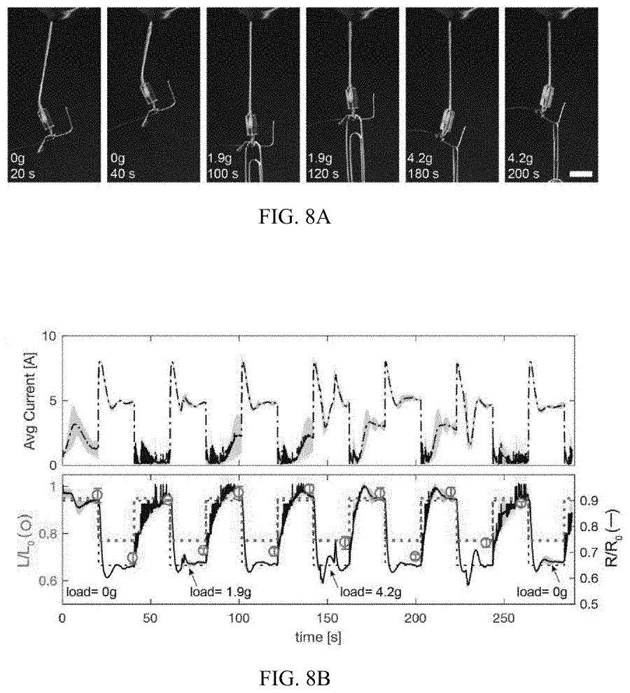

Given that iLCEs are able to reversibly actuate with self-sensing capabilities and exert substantial work, regulation of their actuation response via closed loop control is explored. Specifically, a control system is programmed with a target R/R₀ that autoregulates iLCE resistance feedback to reach the target over time, even with bias stress perturbations. FIG. 8A shows optical images of a representative iLCE fiber with self-adjusting actuation under several loading conditions (scale bar=10 mm). FIG. 8B shows a self-adjusting current profile (top) and change in resistance and length (bottom) as a function of time for iLCE fibers that are perturbed with bias loads, while reaching target values of resistance (black, dashed) and corresponding length (red, dashed), where the lines denote average values, and shaded regions or error bars indicate standard deviations. A target resistance square wave is designated with two targets R/R₀=0.90 and R/R₀=0.65 for 20 s each, corresponding to target contractile strains of approximately 5% and 23%, respectively. The current rapidly self-adjusts without manual intervention, such that the R/R₀ values of the iLCEs lie within the target resistance curve with 3.1% and 4.5% overshoot and undershoot, respectively. Importantly, the iLCE actuators are capable of tracking self-sensing actuation while rejecting disturbances up to 4.2 grams (greater than 115 times the liquid crystal elastomer weight) within 20 s, as shown in FIG. 8B.

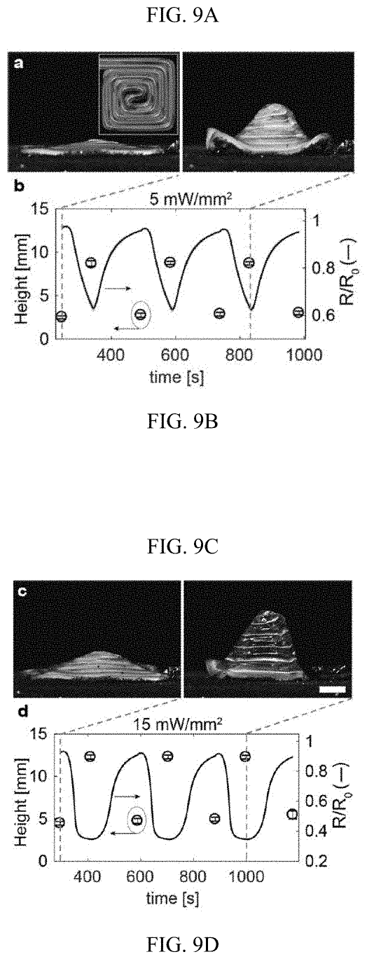

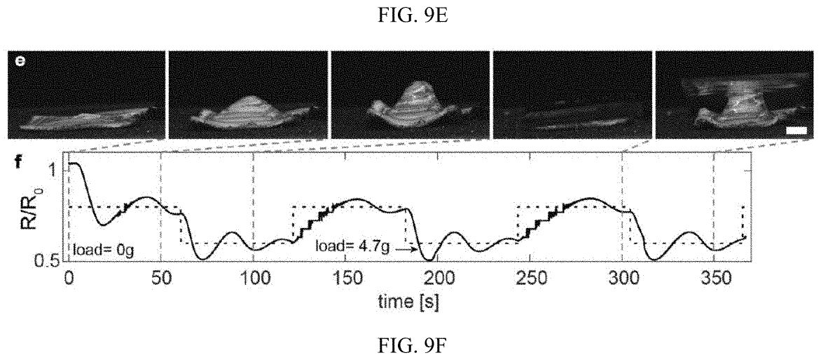

As a final demonstration, iLCE spirals are fabricated with 2D director patterning via 3D printing to achieve a programmable out-of-plane shape change. Specifically, the iLCE is patterned with a square spiral print path, which is expected to actuate into a cone when heated above T_{NI}. Like its fiber actuator counterparts, spiral iLCEs are repeatedly actuated via Joule heating and output a corresponding change in resistance. At low power input (5 mW mm⁻²), a fraction of the iLCE actuates and forms a partial cone, corresponding to a maximum height of 8.77 mm±1.9% with corresponding R/R₀ of 0.63±2.0%, as shown in FIGS. 9A and 9B. At higher power input (15 mW mm⁻²) almost the entire structure is above T_{NI} and actuates into a full cone with a maximum height of 12.29 mm±1.6% and corresponding R/R₀ of 0.35±1.5%, as shown in FIGS. 9C and 9D. The frequency of cycling current is slow to allow cooling of the large structure, with cycles 2-4 shown in the figures. With sufficient time to cool, the spiral iLCEs return to a flat shape and within 5% of the initial R/R₀. The reversible and large change in resistance corresponding to the change in height enables closed loop control of 3D shape change. As shown in FIGS. 9E and 9F, a target resistance curve with 60 s intervals at R/R₀=0.8 and R/R₀=0.6 is programmed and the iLCE spiral actuates to these targets both with and without a bias load (4.7 g). The scale bars equal 5 mm for the preceding figures, and the lines denote average values, while shaded regions or error bars indicate standard deviations. Longer time intervals relative to those of iLCE fibers are necessary due to the scale of the iLCE spiral and ensuing timescale of heat dissipation. This capability could be deployed in the future to create reconfigurable iLCE-based antennae with closed loop control, and, hence, tunable RF properties.

The fabrication of innervated LCEs with programmable actuation, self-sensing, and closed loop control via core-shell 3D printing has been demonstrated. Importantly, this approach enables liquid metal and other core materials as described above to be directly embedded within LCE-based coaxial fibers. These iLCE fibers exhibit prescribed and predictable thermal responses, strain, and self-sensing upon Joule heating, with strains of nearly 50% when heated above their nematic-to-isotropic transition temperature. Programmability, repeatability, magnitude of sensing signal, and large work output enable closed loop control of printed 1D iLCE fibers and 2D-to-3D shape-morphing architectures, respectively. With further development, iLCE architectures in arbitrary designs could be printed and controlled in a closed loop system for use in intelligent soft robotics, reconfigurable soft electronics, and RF devices.

### Experimental Details

Materials: The LCE ink is prepared using an aza-Michael addition method. A 1.1:1 molar ratio of 1,4-bis-[4-(6-acryloyloxy-hexyloxy)benzoyloxy]-2-methylbenzene (Wilshire Technologies Inc.) and n-butylamine (Sigma-Aldrich), 0.2 wt% butylated hydroxy toluene (Fisher Scientific), and 2 wt % Irgacure 651 (BASF) are combined, stirred, and heated at 105° C. for 18 h in the absence of light. The ink is transferred to a custom stainless steel barrel and degassed in a vacuum oven (VWR) overnight prior to printing. A liquid metal (LM) ink composed of eutectic gallium indium (5N Plus) is used as-received.

Core-shell 3D printing: Core-shell nozzles are first produced using stereolithography (Perfactory Aureus, Envisiontec) and subsequently coated with 1H,1H,2H,2H-perfluorooctyltriethoxysilane (FOTS, Oakwood Chemical) to minimize crosslinking with the LCE ink. The nozzle dimensions are provided in Figure S9. The LCE ink is extruded through the outer shell of the coaxial nozzle by applying pressure (Ultimus V, Nordson EFD). A polyimide flexible heater (McMaster-Carr) is wrapped around the nozzle to maintain a constant temperature of 25° C. The LM ink is extruded through the inner core of the nozzle using a syringe pump (PHD Ultra, Harvard Apparatus). During printing, the core-shell printhead is tilted 20° from the vertical axis to improve printability of innervated LM (core)-LCE (shell) architectures, referred to as iLCEs. These iLCE have ellipsoidal cross-sections, with initial major and minor diameters of 1.34±0.12 mm×0.93±0.08 mm and 0.702±0.04 mm×0.571±0.05 mm for the LCE shell and LM core, respectively.

iLCEs are printed in the form of 1D coaxial fibers and 2D-to-3D shape morphing structures using a custom-built, three-axis motion controlled stage (Aerotech Inc.) equipped with on-the-fly UV crosslinking at ˜8 mW cm⁻² intensity (Omnicure, S2000). iLCEs fibers and spiral-based planar structure are printed on a polyvinyl alcohol (80% hydrolized, Aldrich)-coated glass substrates or pre-cleaned glass substrates (VWR), respectively, to allow release from the substrate without deformation. Spiral iLCEs are printed on a rotary stage (Aerotech Inc.), since the tilted nozzle prevents extrusion in both positive and negative x-directions. iLCE fibers are typically printed by extruding the LCE ink at an applied pressure of 3.6 MPa and the LM ink at a flow rate of 0.0197 mL min⁻¹ with a print speed of 2 mm s⁻¹ and a print height of 0.25 mm. Spiral iLCEs are printed with a 1.7 mm center-to-center spacing between filaments using under the same conditions, except at a reduced print speed of 0.85 mm s⁻¹. At the start and end of each printed iLCE, the LCE ink is over-extruded by reducing the print speed by a factor of 2 as the nozzle is translated for 5 mm in the desired direction. After printing, the iLCEs are fully crosslinked by an additional UV exposure step of 30 min in duration on each side (S2000, Omnicure; ˜5 mW cm⁻²).

As a final step, a 23 AWG copper wire (Diji-Key Corp.) is mechanically filed, inserted in the iLCEs, connected to their LM core, and sealed with an adhesive (NOA 68, Norland Inc.) that promotes bonding upon crosslinking with UV light (S2000, Omnicure; minimum 300 s). A 28 AWG compliant lead wire (Diji-Key Corp.) of roughly 10 cm length is then soldered onto one end of iLCE fibers as to not affect LCE L/L₀ and R/R₀. Spiral iLCEs do not require a lead wire.

The subject matter of the disclosure may also relate to, among others, the following aspects:

A first aspect relates to a method of forming an actuator, the method comprising: extruding a filament through a nozzle moving relative to a substrate, the filament having a core-shell structure including a shell comprising a liquid crystal elastomer surrounding a core; subjecting the filament to UV curing as the filament is extruded; and depositing the filament on the substrate as the nozzle moves, a director of the liquid crystal elastomer being aligned with a print path of the nozzle, thereby forming a 3D printed architecture configured for actuation.

A second aspect relates to the method of the first aspect, wherein the core contains a core material configured to generate, deliver or transmit an activator of a nematic-to-isotropic transition of the liquid crystal elastomer.

A third aspect relates to the method of any preceding aspect, wherein the core contains a fugitive material, and further comprising, after depositing the filament on the substrate, removing the fugitive material from the core and introducing a core material configured to generate, deliver or transmit an activator of a nematic-to-isotropic transition of the liquid crystal elastomer into the core.

A fourth aspect relates to the method of any preceding aspect, wherein the core contains a fugitive material, and further comprising, after depositing the filament on the substrate, removing the fugitive material from the core, thereby forming a hollow core configured to transmit an activator of a nematic-to-isotropic transition of the liquid crystal elastomer.

A fifth aspect relates to the method of any of the second through the fourth aspects, wherein the activator of the nematic-to-isotropic transition of the liquid crystal elastomer comprises light, heat, voltage, and/or a chemical gradient.

A sixth aspect relates to the method of any of the first through the third or the fifth aspect, wherein the core material is configured to transmit light and/or electric current, and wherein the core material comprises a liquid metal or a polymer.

A seventh aspect relates to the method of the sixth aspect, wherein the liquid metal comprises Ga, In, Sn, and/or Hg.

An eighth aspect relates to the method of the sixth aspect, wherein the polymer comprises a conductive polymer and/or a light transmissive polymer.

A ninth aspect relates to the method of the eighth aspect, wherein the conductive polymer comprises carbon grease, a metal paste, and/or another soft composite electronics formulation.

A tenth aspect relates to the method of any preceding aspect, wherein, during the extrusion, the nozzle is inclined at an angle between 1° and 60° and/or between 5° and 45° with respect to an axis normal to the substrate.

An eleventh aspect relates to the method of any preceding aspect, wherein the filament has an elliptical cross-section.

A twelfth aspect relates to the method of any preceding aspect, wherein the nozzle includes a core channel and a shell channel surrounding the core channel, and wherein, prior to the extrusion, a core material or a fugitive material passes through the core channel and the liquid crystal elastomer passes through the shell channel.

A thirteenth aspect relates to the method of the twelfth aspect, wherein one or both of (a) the core material or the fugitive material, and (b) the liquid crystal elastomer passes through the respective channel at a predetermined flow rate.

A fourteenth aspect relates to the method of the thirteenth aspect, wherein the predetermined flow rate lies in a range from about 0.01 ml/min and about 0.1 ml/min.

A fifteenth aspect relates to the method of the twelfth aspect, wherein one or both of (a) the core material or the fugitive material, and (b) the liquid crystal elastomer passes through the respective channel at a predetermined pressure.

A sixteenth aspect relates to the method of the fifteenth aspect, wherein the predetermined pressure lies in a range from about 1 MPa to about 10 MPa.

A seventeenth aspect relates to the method of any preceding aspect, wherein the shell channel is retracted relative to the core channel at an exit of the nozzle, such that the liquid crystal elastomer exits the shell channel before the core material or the fugitive material exits the core channel.

An eighteenth aspect relates to the method of any preceding aspect, wherein the nozzle moves relative to the substrate at a print speed in a range from about 0.5 mm/s to about 5 mm/s.

A nineteenth aspect relates to the method of any preceding aspect, further comprising over-extruding the liquid crystal elastomer at a beginning and an end of the extrusion to locally disrupt director alignment.

A twentieth aspect relates to the method of the nineteenth aspect, wherein the over-extruding comprises reducing print speed by at least about a factor of 1.5, or at least about a factor of 2.

A twenty-first aspect relates to the method any preceding aspect, wherein, during the extrusion, the nozzle is maintained at a predetermined temperature.

A twenty-second aspect relates to the method of the twenty-first aspect, wherein, during the extrusion, a flexible heater is wrapped about the nozzle.

A twenty-third aspect relates to the method of any preceding aspect, wherein the UV curing is carried out using ultraviolet light having an intensity in a range from about 6 mW cm⁻² to about 10 mW cm⁻².

A twenty-fourth aspect relates to the method of any preceding aspect, comprising, after depositing the filament on the substrate, subjecting the filament to an additional UV curing step to fully crosslink the liquid crystal elastomer.

A twenty-fifth aspect relates to the method of the twenty-fourth aspect, wherein the additional UV curing step is carried out by exposing the filament to ultraviolet light for at least about 20 min, or at least about 30 min.

A twenty-sixth aspect relates to the twenty-fourth or twenty-fifth aspect, wherein the additional UV curing step is carried out using UV light having an intensity in a range from about 3 mW cm⁻² to about 7 mW cm⁻²

A twenty-seventh aspect is related to an actuator comprising: a 3D printed architecture comprising a filament having a core-shell structure including a shell comprising a liquid crystal elastomer surrounding a core configured to induce a nematic-to-isotropic transition of the liquid crystal elastomer, a director of the liquid crystal elastomer being aligned with a longitudinal axis of the filament, wherein, when the nematic-to-isotropic transition of the liquid crystal elastomer is induced, the director loses alignment and the 3D printed architecture is actuated.

A twenty-eighth aspect is related to the actuator of the preceding aspect, wherein the nematic-to-isotropic transition of the liquid crystal elastomer is activated by light, heat, voltage, a chemical gradient, and/or another activator.

A twenty-ninth aspect is related to the actuator of any preceding aspect, wherein the core is a hollow core configured to transmit an activator of the nematic-to-isotropic transition of the liquid crystal elastomer.

A thirtieth aspect is related to the actuator of the twenty-seventh or twenty-eighth aspect, wherein the core contains a core material configured to generate, deliver or transmit an activator of the nematic-to-isotropic transition of the liquid crystal elastomer.

A thirty-first aspect is related to the actuator of the thirtieth aspect, wherein the core material is configured to transmit light and/or electric current.

A thirty-second aspect is related to the actuator of the thirtieth or thirty-first aspect, wherein the core material comprises a liquid metal or a polymer.

A thirty-third aspect is related to the actuator of the thirty-second aspect, wherein the liquid metal comprises Ga, In, Sn, and/or Hg.

A thirty-fourth aspect is related to the actuator of the thirty-second aspect, wherein the polymer comprises a conductive polymer and/or a light transmissive polymer.

A thirty-fifth aspect is related to the actuator of the thirty-third aspect, wherein the conductive polymer comprises carbon grease, a metal paste, and/or another soft composite electronics formulation.

A thirty-sixth aspect is related to the actuator of any of the twenty-seventh through the thirty-fifth aspects, wherein the core has a transverse cross-sectional area at least about 40% as large, at least about 50% as large, or at least about 60% as large as a total transverse cross-sectional area of the filament.

A thirty-seventh aspect is related to the actuator of any of the twenty-seventh through the thirty-sixth aspects, comprising more than one nematic-to-isotropic transition induced at different temperatures, wavelengths, voltages, and/or chemical gradients.

A thirty-eighth aspect is related to the actuator of any of the twenty-seventh through the thirty-seventh aspects, wherein the shell comprises a plurality of liquid crystal elastomers arranged in concentric layers or in a longitudinal stack.

A thirty-ninth aspect is related to an actuation method comprising: providing a 3D printed architecture comprising a filament having a core-shell structure, where the core-shell structure includes a shell comprising a liquid crystal elastomer surrounding a core configured to induce a nematic-to-isotropic transition of the liquid crystal elastomer, and where a director of the liquid crystal elastomer is aligned with a longitudinal axis of the filament; inducing the nematic-to-isotropic transition of the liquid crystal elastomer, whereby alignment of the director is lost, thereby actuating the 3D printed architecture.

A fourtieth aspect is related to the actuation method of any preceding aspect, wherein the core is a hollow core configured to transmit an activator of the nematic-to-isotropic transition of the liquid crystal elastomer.

A forty-first aspect is related to the actuation method of any preceding aspect, wherein the core contains a core material configured to generate, deliver or transmit an activator of the nematic-to-isotropic transition of the liquid crystal elastomer.

A forty-second aspect is related to the actuation method of any preceding aspect, wherein the actuation of the 3D printed architecture comprises contraction of the filament along the longitudinal axis.

A forty-third aspect is related to the actuation method of any preceding aspect, wherein the nematic-to-isotropic transition of the liquid crystal elastomer is induced by exposure to light, heat, voltage, a chemical gradient and/or another activator.

A forty-fourth aspect is related to the actuation method of any preceding aspect, wherein the core material is configured to transmit light and/or electric current, and wherein the core material comprises a liquid metal or a polymer.

A forty-fifth aspect is related to the actuation method of the forty-fourth aspect, wherein the liquid metal comprises Ga, In, Sn, and/or Hg.

A forty-sixth aspect is related to the actuation method of the forty-fourth aspect, wherein the polymer comprises a conductive polymer and/or a light transmissive polymer.

A forty-seventh aspect is related to the actuation method of the forty-sixth aspect, wherein the conductive polymer comprises carbon grease, a metal paste, and/or another soft composite electronics formulation.

A forty-eighth aspect is related to the actuation method of any preceding aspect, wherein the core has a transverse cross-sectional area at least about 40% as large, at least about 50% as large, or at least about 60% as large as a total transverse cross-sectional area of the filament.

A forty-fifth aspect is related to the actuation method of any preceding aspect, comprising more than one nematic-to-isotropic transition induced at different temperatures, wavelengths, voltages, and/or chemical gradients.

A forty-sixth aspect is related to the actuation method of any preceding aspect, the shell comprises a plurality of liquid crystal elastomers arranged in concentric layers or in a longitudinal stack.

A forty-seventh aspect is related to the actuation method of the forty-sixth aspect, wherein the 3D printed architecture contracts in a gradual or step-wise manner as the liquid crystal elastomers are activated at different times.

Although the present invention has been described in considerable detail with reference to certain embodiments thereof, other embodiments are possible without departing from the present invention. The spirit and scope of the appended claims should not be limited, therefore, to the description of the preferred embodiments contained herein.

All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

1. A method of forming an actuator, the method comprising:
extruding a filament through a nozzle moving relative to a substrate, the filament having a core-shell structure including a shell comprising a liquid crystal elastomer surrounding a core;
subjecting the filament to UV curing as the filament is extruded; and
depositing the filament on the substrate as the nozzle moves, a director of the liquid crystal elastomer being aligned with a print path of the nozzle, thereby forming a 3D printed architecture configured for actuation.

2. The method of claim 1, wherein the core contains a core material configured to generate, deliver or transmit an activator of a nematic-to-isotropic transition of the liquid crystal elastomer.

3. The method of claim 1, wherein the core contains a fugitive material, and further comprising, after depositing the filament on the substrate, removing the fugitive material from the core and introducing a core material configured to generate, deliver or transmit an activator of a nematic-to-isotropic transition of the liquid crystal elastomer into the core.

4. The method of claim 1, wherein the core contains a fugitive material, and further comprising, after depositing the filament on the substrate, removing the fugitive material from the core, thereby forming a hollow core configured to transmit an activator of a nematic-to-isotropic transition of the liquid crystal elastomer.

5. The method of claim 1, wherein the activator of the nematic-to-isotropic transition of the liquid crystal elastomer comprises light, heat, voltage, and/or a chemical gradient.

6. The method of claim 1, wherein, during the extrusion, the nozzle is inclined at an angle between 1° and 60° with respect to an axis normal to the substrate.

7. The method of claim 1, wherein the filament has an elliptical cross-section.

8. An actuator comprising:
a 3D printed architecture comprising a filament having a core-shell structure including a shell comprising a liquid crystal elastomer surrounding a core configured to induce a nematic-to-isotropic transition of the liquid crystal elastomer, a director of the liquid crystal elastomer being aligned with a longitudinal axis of the filament,
wherein, when the nematic-to-isotropic transition of the liquid crystal elastomer is induced, the director loses alignment and the 3D printed architecture is actuated.

9. The actuator of claim 8, wherein the core is a hollow core configured to transmit an activator of the nematic-to-isotropic transition of the liquid crystal elastomer.

10. The actuator of claim 8, wherein the core contains a core material configured to generate, deliver or transmit an activator of the nematic-to-isotropic transition of the liquid crystal elastomer.

11. The actuator of claim 8, wherein the core material comprises a liquid metal or a polymer.

12. The actuator of claim 8, wherein the core has a transverse cross-sectional area at least about 40% as large as a total transverse cross-sectional area of the filament.

13. The actuator of claim 8, wherein the shell comprises a plurality of liquid crystal elastomers arranged in concentric layers or in a longitudinal stack.

14. An actuation method, the actuation method comprising:
providing a 3D printed architecture comprising a filament having a core-shell structure, where the core-shell structure includes a shell comprising a liquid crystal elastomer surrounding a core configured to induce a nematic-to-isotropic transition of the liquid crystal elastomer, and where a director of the liquid crystal elastomer is aligned with a longitudinal axis of the filament;
inducing the nematic-to-isotropic transition of the liquid crystal elastomer, whereby alignment of the director is lost, thereby actuating the 3D printed architecture.

15. The actuation method of claim 14, wherein the core is a hollow core configured to transmit an activator of the nematic-to-isotropic transition of the liquid crystal elastomer.

16. The actuation method of claim 14, wherein the core contains a core material configured to generate, deliver or transmit an activator of the nematic-to-isotropic transition of the liquid crystal elastomer.

17. The actuation method of claim 14, wherein the actuation of the 3D printed architecture comprises contraction of the filament along the longitudinal axis.

18. The actuation method of claim 14, wherein the nematic-to-isotropic transition of the liquid crystal elastomer is induced by exposure to light, heat, voltage, a chemical gradient and/or another activator.

19. The actuation method of claim 14, comprising more than one nematic-to-isotropic transition induced at different temperatures, wavelengths, voltages, and/or chemical gradients.

20. The actuation method of claim 14, wherein the shell comprises a plurality of liquid crystal elastomers arranged in concentric layers or in a longitudinal stack, and
wherein the 3D printed architecture contracts in a gradual or step-wise manner as the liquid crystal elastomers are activated at different times.
